(19) United States
(12) Patent Application Publication
(10) Pub. No.: US 2009/0284790 A1
(43) Pub. Date: Nov. 19, 2009

(54) INFORMATION PROCESSING APPARATUS, INFORMATION PROCESSING METHOD, COMPUTER PROGRAM PRODUCT THAT CAUSES THE APPARATUS TO EXECUTE THE METHOD, AND IMAGE FORMING APPARATUS INCORPORATING THE INFORMATION PROCESSING APPARATUS

(76) Inventor: Yasuo Ohashi, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/463,610

(22) Filed: May 11, 2009

(30) Foreign Application Priority Data
May 13, 2008 (JP) 2008-125396

(51) Int. Cl. G06F 3/12

(52) U.S. Cl. 358/1.15

(57) ABSTRACT

An information processing apparatus includes a communication unit to communicate with an external device, a receiver to receive a signal from an identification information transmitter that transmits at least one of identification information of a user of the external device and identification information of the external device, a measurement circuit to measure strength of a received signal, a storage unit to store correlation data between a relative distance to the identification information transmitter and the strength of the received signal, a calculation circuit to calculate from the field intensity of the received signal the relative distance based on the correlation data, an operation controller to control operation of the information processing apparatus based on a result of calculation of the relative distance, and a correction unit to correct the correlation data based on the field intensity of the received signal from the identification information transmitter disposed at a predetermined range.

### CROSS-REFERENCE TO RELATED APPLICATIONS

This patent application is based on and claims priority pursuant to 35 U.S.C. §119 from Japanese Patent Application No. 2008-125396 filed on May 13, 2008 in the Japan Patent Office, the entire contents of which are hereby incorporated herein by reference.

### BACKGROUND OF THE INVENTION

1. Field of the Invention

Exemplary aspects of the present invention generally relate to an information processing apparatus, an information processing method, a computer program product that causes the apparatus to execute the method, and an image forming apparatus including the information processing apparatus.

2. Description of the Background Art

Generally, an image forming apparatus such as a printer includes an information processing apparatus connected to an information processing terminal through a network. When a user operates the information processing terminal to send data and print instructions to the image forming apparatus, the image forming apparatus initiates printing after completion of reception of the data and discharges a printed recording sheet onto a sheet tray.

For example, when using a generally-known printer shared by multiple users in an office, the user uses his or her personal computer or the like to designate a print data file and transfer the print data to a designated printer that outputs the print data. When the printer receives the print data, the printer executes print processing including generation of image data. After the image data is generated, an image is formed and printed on the recording sheet. Then, the recording sheet is discharged.

Such a printer does not necessarily print out and discharge the printed document when the user prefers. Thus, there is a possibility that the printed document can be seen without authorization or even stolen before the user retrieves the printed document.

To prevent the printed document from getting stolen and to enhance security, there is known a printer that receives data at any time but which does not start printing or discharging the printed document until the user performs a an authentication operation at the printer. Such a printer prints out and discharges the printed document based on the received data after the user is authenticated.

Furthermore, there is another known printer that discharges the printed document onto an internal sheet tray provided inside the printer so that the printed document cannot be retrieved until the user authentication is completed. In such a printer, only after the user is authenticated is the printed document discharged onto an external sheet tray. Alternatively, such a printer is equipped with a lock mechanism that allows the user to retrieve the printed document from the internal sheet tray after the user is authenticated.

In general, the authentication of the user involves the user entering authentication information such as an ID or a password through a control panel of the printer, or the user scans his/her IC card through an IC card reader connected to the printer. In other words, in the related art printer, the printer does not start print operation unless the user goes to the printer and performs a predetermined authentication operation.

Thus, a drawback of the foregoing configuration is that when the user needs to print out frequently, the user has to go to the printer and repeat the same authentication operation in order to print out and discharge the printed document, causing complication and a long waiting period. In particular, in the printer that employs a thermal fixing method, a warm-up period tends to be long so that the user needs to wait in front of the printer for a long time until printing is completed and the printed document is discharged.

Furthermore, the printer that discharges the printed document onto the internal sheet tray needs dedicated mechanisms as well as separate sheet trays for the printed document for each user. Consequently, the size of the printer as a whole increases as the number of trays increases, thereby limiting the type and number of possible installation sites for the printer.

To address the above-described problems, in one related-art image forming apparatus, when the image forming apparatus receives authentication information of the user from an IC card or the like that the user possesses through wireless communication, the image forming apparatus identifies the user based on the authentication information, automatically sets a login name of the user, and then shows the login name on the control panel. Accordingly, the image forming apparatus is ready to receive a password from the user, eliminating need for the user to enter the login name and thus simplifying operation for the user.

However, a drawback to this approach is that printing and other operations are initialized only after the user enters his or her password and authentication of the user is completed. This means that the user still needs to wait in front of the image forming apparatus until printing is finished and the printed document is discharged. The waiting period and convenience are still not improved.

In such an image forming apparatus, there is a correlation between a distance between the IC card and the image forming apparatus, on the one hand, and strength of a radio wave (hereinafter “signal”) or an electric field that the image forming apparatus receives from the IC card. In other words, the shorter the relative distance between the image forming apparatus and the IC card, the stronger the signal. By contrast, the longer the relative distance between the image forming apparatus and the IC card, the weaker the signal.

However, this correlation between the intensity of the signal from the IC card or the like and the relative distance between a signal receiver and a transmitter is not constant but varies due to unit-to-unit variation. If the relative distance is obtained assuming that the correlation is constant, an accurate determination of the relative distance and concomitant closeness of the IC card is difficult to obtain.

In addition, in such a related-art image forming apparatus, when there is no response from the IC card via the wireless communication for a certain period of time, and/or it is determined that the IC card is not in the vicinity of the image forming apparatus, the login screen shown on the control panel is turned off so as to increase security.

In order to turn off the login screen as the IC card moves away from the image forming apparatus while maintaining communication between the image forming apparatus and the IC card, the image forming apparatus needs to include a detector to accurately detect the distance between the IC card and the image forming apparatus. However, the related-art image forming apparatus does not include such a detector.

Furthermore, in this image forming apparatus, only the display on the control panel is controlled through wireless communication. Thus, for example, this image forming apparatus does not automatically shift to or recover from a power-saving mode based on the result of the wireless communication. Moreover, the image forming apparatus does not stop printing or alert the user visually or by an audio alarm when an unauthorized user who does not have right of access to the print data approaches the image forming apparatus.

Accordingly, there is a need for an image forming apparatus and associated technology that reduces energy consumption while providing enhanced security.

### SUMMARY OF THE INVENTION

In view of the foregoing, in one illustrative embodiment of the present invention, an information processing apparatus includes a communication unit to communicate with an external device, receiver to receive a signal from an identification information transmitter that transmits at least one of identification information of a user of the external device and of the external device, a measurement circuit to measure a field intensity of a received signal, a storage unit to store correlation data between a relative distance to the identification information transmitter and the field intensity of the received signal, a calculation circuit to calculate from the field intensity of the received signal the relative distance based on the correlation data, an operation controller to control operation of the information processing apparatus based on a result of calculation of the relative distance, and a correction unit to correct the correlation data based on the field intensity of the received signal from the identification information transmitter disposed at a predetermined range.

In another illustrative embodiment of the present invention, a control method is used in an information processing apparatus including a communication unit to communicate with an external device, a receiver to receive a signal from an identification information transmitter that transmits at least one of identification information of a user of the external device and of the external device, a measurement circuit to measure a field intensity of a received signal, a storage unit to store correlation data between a relative distance to the identification information the field intensity of the received signal, a calculation circuit to calculate from the field intensity of the received signal the relative distance based on the correlation data, an operation controller to control operation of the information processing apparatus based on a result of calculation of the relative distance, and a correction unit to correct the correlation data based on the field intensity of the received signal from the identification information transmitter disposed at a predetermined range. The method includes communicating, receiving, measuring, calculating, controlling, correcting, and storing. The communicating communicates with an external device. The receiving receives a signal from an identification information transmitter that transmits at least one of identification information of a user of the external device and of the external device. The measuring measures a field intensity of a received signal. The calculating calculates, from the field intensity of the received signal, a relative distance to the identification information transmitter based on correlation data between the relative distance and the field intensity of the received signal. The controlling controls operation of the information processing apparatus based on a result of calculation of the relative distance. The correcting corrects the correlation data based on the field intensity of the received signal from the identification information transmitter disposed at a predetermined range. The storing stores the corrected correlation data.

Yet in another illustrative embodiment of the present invention, a computer program product includes a computer-usable medium having computer-readable program codes embodied in the medium that, when executed, causes a computer to execute a control method. The method includes communicating, receiving, measuring, calculating, controlling, correcting, and storing. The communicating communicates with an external device. The receiving receives a signal from an identification information transmitter that transmits at least one of identification information of a user of the external device and of the external device. The measuring measures a field intensity of a received signal. The calculating calculates, from the field intensity of the received signal, a relative distance to the identification information transmitter based on correlation data between the relative distance and the field intensity of the received signal. The controlling controls operation of the information processing apparatus based on a result of calculation of the relative distance. The correcting corrects the correlation data based on the field intensity of the received signal from the identification information transmitter disposed at a predetermined range. The storing stores the corrected correlation data.

Additional features and advantages of the present invention will be more fully apparent from the following detailed description of illustrative embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description of illustrative embodiments when considered in connection with the accompanying drawings, wherein:

FIG. 1 is a schematic diagram illustrating an information processing system according to an illustrative embodiment of the present invention;

FIG. 2 is a block diagram illustrating the information processing system of FIG. 1 according to an illustrative embodiment of the present invention;

FIG. 3 is a conversion table for a relative distance and a field intensity of a received signal according to an illustrative embodiment of the present invention; and

FIG. 4 is a flowchart showing an exemplary procedure for printing according to an illustrative embodiment of the present invention.

### DETAILED DESCRIPTION OF ILLUSTRATIVE EMBODIMENTS

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Illustrative embodiments of the present invention are now described below with reference to the accompanying drawings.

In a later-described comparative example, illustrative embodiment, and alternative example, for the sake of simplicity of drawings and descriptions, the same reference numerals will be given to constituent elements such as parts and materials having the same functions, and redundant descriptions thereof omitted.

Typically, but not necessarily, paper is the medium from which is made a sheet on which an image is to be formed. It should be noted, however, that other printable media are available in sheet form, and accordingly their use here is included. Thus, solely for simplicity, although this Detailed Description section refers to paper, sheets thereof, paper feeder, etc., it should be understood that the sheets, etc., are not limited only to paper, but includes other printable media as well.

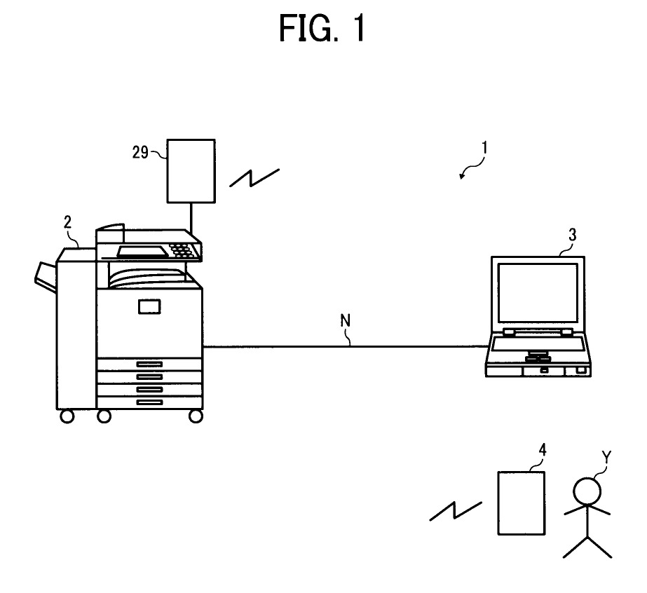

Referring now to the drawings, wherein like reference numerals designate identical or corresponding parts throughout the several views, and initially to FIG. 1, one example of an information processing system according to an illustrative embodiment of the present invention is described.

Referring now to FIG. 1, there is provided a diagram schematically illustrating one example of the information processing system 1, according to the illustrative embodiment. The information processing system 1 includes a digital multi-functional peripheral (MFP) as an example of an image forming apparatus 2 and an identification information transmitter 4.

The image forming apparatus 2 is equipped with an information processing apparatus that communicates with an external device used by a user such as an external information processing terminal, a network, and so forth. The image forming apparatus 2 may serve as the information processing apparatus.

The identification information transmitter 4 is carried by the user of the external device and wirelessly sends the identification information that identifies the user and so forth using a signal.

According to the illustrative embodiment, the image forming apparatus 2, that is, the digital multifunctional peripheral (MFP), includes at least two of the following functions: a copying machine, a printer, a facsimile machine, a scanner, and so forth.

The external device herein includes a personal computer 3 (hereinafter referred to as a PC) connected to the image forming apparatus 2 through a Local Area Network (hereinafter referred to as a LAN). Upon reception of instruction from the user, the image forming apparatus 2 executes print operation or copy operation.

### Embodiment 1

FIG. 1 is a diagram schematically illustrating the information processing system 1 according to the illustrative embodiment. As illustrated in FIG. 1, the information processing system 1 includes the image forming apparatus 2, at least one PC 3, and the identification information transmitter 4 carried by a user of the PC 3.

In FIG. 1, only one PC 3 is illustrated. However, the number of PCs 3 is not limited to one, and the information processing system 1 may include a plurality of PCs 3.

The image forming apparatus 2 includes the information processing apparatus equipped with a communication device, not illustrated, to communicate with the PC 3 so that data including print data, control signals, and so forth is transmitted to and received from the PC 3 through a network cable N.

The information processing apparatus of the image forming apparatus 2 includes also a wireless communication module 29 and an operation controller 50 the detail description of which is provided later.

The wireless communication module 29 is embedded or externally connected to the image forming apparatus 2. The wireless communication module 29 communicates wirelessly with the identification information transmitter 4 and serves as a main unit for wireless transmission and reception of data.

With this configuration, the image forming apparatus 2 periodically and wirelessly transmits identification information of the image forming apparatus itself to the outside thereof through a signal, and receives a signal wirelessly transmitted from outside such as from the identification information transmitter 4.

According to the illustrative embodiment, the identification information transmitter 4 is not a passive-type wireless communication device such as a Radio Frequency Identification (RFID) tag or the like. Instead, the identification information transmitter 4 is an active-type external wireless communication device (wireless sub-unit) powered by an internal power source such as a battery and receives the signal.

The identification information transmitter 4 transmits identification information that identifies the user Y. The identification information includes, for example, the identification information of the identification transmitter 4 and an ID of the user Y.

The identification information transmitter 4 includes a low-power wireless data communication device such as a specified low-power radio that consumes less power than the communication device of the image forming apparatus 2 through the network, for example. The identification information transmitter 4 can wirelessly communicate even if the identification information transmitter 4 is at a relatively remote location from the wireless communication module 29 of the image forming apparatus 2.

Each of a plurality of the users Y who use the PCs 3 possesses the identification information transmitter 4. Periodically or upon reception of the identification information from the image forming apparatus 2, the identification information transmitter 4 sends appropriate identification information for the user Y to the image forming apparatus. When the user Y approaches the wireless communication module 29 of the image forming apparatus 2 close enough to wirelessly communicate with the wireless communication module 29, the identification information transmitter 4 performs a predetermined wireless communication.

The PC 3 is connected to the image forming apparatus 2 through the network cable N constituting the LAN. The user Y having the identification information transmitter 4 operates the PC 3 to send image data and a print instruction to the image forming apparatus 2.

In the information processing system 1 as described above, each user Y has the identification information transmitter 4 that includes different identification information associated with different users Y. Each user Y carries the identification information transmitter 4 and operates the PC 3.

Alternatively, after operation of the PC 3, the user Y moves to the image forming apparatus 2 carrying his or her identification information transmitter 4 and enables the image forming apparatus 2 to print.

According to the illustrative embodiment, the identification information transmitter 4 is in the vicinity of the user Y or substantially at the same location as the user Y when the identification information transmitter 4 approaches the image forming apparatus 2.

In accordance with reception of the identification information of the user Y, the image forming apparatus 2 executes a predetermined operation as described later. At this time, in the information processing system 1, the image forming apparatus 2 calculates a relative distance between the image forming apparatus 2 and each of the identification information transmitter 4 in a moving state and/or at a remote location, and controls the image forming apparatus 2 according to the results of that calculation.

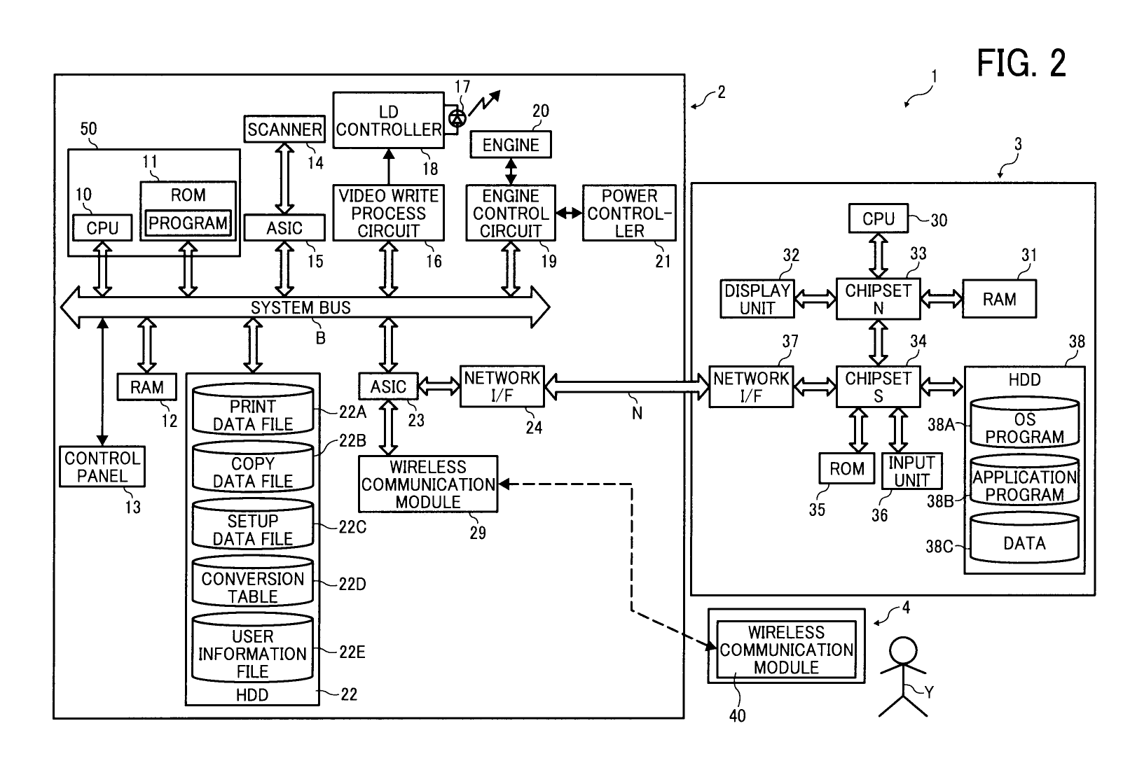

Referring now to FIG. 2, there is provided a block diagram showing the information processing system 1 and the internal configuration of the image forming apparatus 2 and the PC 3.

As illustrated in FIG. 2, the PC 3 includes a Central Processing Unit (CPU) 30, a Random Access Memory (RAM) 31, a display unit 32, a chipset N33, a chipset S34, a Read Only Memory (ROM) 35, an input unit 36, a network interface (I/F) 37, and a hard disk drive (HDD) 38.

The CPU 30 performs various data processing, calculation, overall control, and so forth. The RAM 31 temporarily stores data necessary for operation and processing of the CPU 30. The display unit 32 includes a display and so forth. The CPU 30, the RAM 31, and the display unit 32 are connected through the chipset N33 connects. The chipset S34 is connected to the chipset N33. The ROM 35 stores programs executed by the CPU 30. The input unit 36 receives input from a keyboard and a pointing device (mouse) used by the user Y. The network interface (I/F) 37 connects to the network to communicate.

The CPU 30 accesses each component of the PC 3 through the chipset N33 and the chipset S34, and reads out a Basic Input/Output System (BIOS) program from the ROM 35 as necessary, decodes, and executes the BIOS program, thereby controlling the display unit 32, the input unit 36, and so forth.

Similarly, the CPU 30 reads out and executes an Operation System (OS) program 38A stored in the HDD 38 and various application programs 38B as necessary. The CPU 30 causes the HDD 38 to store data in a predetermined region of the HDD 38, that is, data 38C.

Accordingly, the CPU 30 accesses input/output modules of both inside and outside the PC 3 to perform overall control. The CPU 30 also communicates with the image forming apparatus 2 through the network I/F 37.

With reference to FIG. 2, a description is provided of the image forming apparatus 2. The image forming apparatus 2 includes an operation controller 50 including a CPU 10 and a ROM 11, a RAM 12, a control panel 13, a scanner 14, an Application Specific Integrated Circuit (ASIC) 15, a video write process circuit 16, a laser diode (LD) controller 18, an engine control circuit 19, an engine 20, a power controller 21, an ASIC 23, a network interface (I/F) 24, the wireless communication module 29, and so forth.

The CPU 10 of the operation controller 50 performs an overall control of the image forming apparatus 2. The ROM 11 stores programs and so forth. The RAM 12 temporarily stores data used for processing for the CPU 10. The control panel 13 serving as a display device includes a screen for displaying information, a numeric keypad, and so forth. The screen herein refers to a control screen including a touch panel or the like.

The ASIC 15 converts a scanner signal from the scanner 14. A laser diode (LD) 17 is connected to the LD controller 18. The engine 20 and the power controller 21 are connected to the engine control circuit 19. The ASIC 23 controls communication with the outside. The network I/F 24 constitutes a network communication mechanism connected to the ASIC 23. Each component is interconnected through a system bus B.

In the image forming apparatus 2, the CPU 10 of the operation controller 50 reads out programs necessary for control and operation from the ROM 11 as needed, and decodes and executes the programs. The data necessary for operation and image data are temporarily stored in the RAM 12.

Accordingly, at least the CPU 10 constitutes the operation controller 50 that controls and directs the information processing apparatus of the image forming apparatus 2, and executes operations described later.

A hard disk drive (HDD) 22 serving as a storage device stores print data (file) 22A, copy data (file) 22B, setup data (file) 22C, and other data and management data necessary for the control described later.

Furthermore, similar to generally known image forming apparatuses, the image forming apparatus 2 performs copying and printing by associating the components with each other. For example, when copying, the ASIC 15 performs various corrections on the image data read by the scanner 14, and then the image data is temporarily stored in the RAM 12.

When a multiple print operation is performed, duplicated image data is temporarily stored in the HDD 22 (in the copy data file 22B). When the image is printed on a recording sheet, each piece of image data is transmitted from the video write process circuit 16 to the LD controller 18. Subsequently, the LD controller 18 controls the LD 17 so as to illuminate a photoreceptor drum, not illustrated, thereby forming an electrostatic latent image (toner image) thereon. The engine control circuit 19 controls the engine 20 such that the toner image is transferred and fixed onto the recording medium at an appropriate timing. Accordingly, normal printing is performed.

Furthermore, in the image forming apparatus 2, the network I/F 24 is connected to the network I/F 37 of the PC 3 through the network cable N, thereby enabling communication and exchange of print data and so forth with the PC 3. The image forming apparatus 2 and the PC 3 are wire-connected by the network, and communicate with each other based on a network protocol such as a Transmission Control Protocol/Internet Protocol (TCP/IP), a User Datagram Protocol (UDP), and so forth.

Alternatively, the image forming apparatus 2 and the PC 3 can communicate using other communication mechanisms such as a designated line and other protocols, or a wireless interface different from the wireless communication module 29.

In addition, in the image forming apparatus 2, the wireless communication module 29 serves as a (wireless communication) receiver that receives a signal of the identification information wirelessly transmitted from the identification information transmitter 4 described above. Corresponding to the wireless communication module 29, the identification information transmitter 4 for each user Y includes a wireless communication module 40.

The wireless communication modules 29 and 40 transmit and receive preset identification information (ID information) through transmission and reception of signals to and from each other when the wireless communication modules 29 and 40 are situated within a predetermined range.

The image forming apparatus 2 receives the identification information of the user Y and references preinstalled user information in the HDD 22 or obtained from an external server via the network to identify the source of the identification information transmitter 4. Subsequently, the user Y of the identification information transmitter 4 is identified, specified, and validated.

The identification information and user-specific information including user names to specify the owner (the user Y) of the identification information transmitter 4 are associated with each other and stored in the HDD 22 as the user information file 22E. The identification information includes an ID number set in the identification information transmitter 4.

The identification information and the user-specific information are read out by the CPU 10 and used to identify and validate the user Y, and so forth.

In the image forming apparatus 2 of the information processing system 1, the wireless communication module 29 and a measurement circuit of the ASIC 23 measure a field intensity of the signal received from the identification information transmitter 4, on the basis of which a relative distance between the image forming apparatus 2 and the source of transmission, that is, the identification information transmitter 4, is calculated. More specifically, the relative distance herein refers to a distance between the wireless communication modules 29 and 40.

Correlation data indicating a correspondence between the relative distance between the image forming apparatus 2 and the identification information transmitter 4, and the field intensity of the received signals, is preset and stored in the HDD 22 of the image forming apparatus 2. In FIG. 2, the correlation data is indicated as a conversion table 22D.

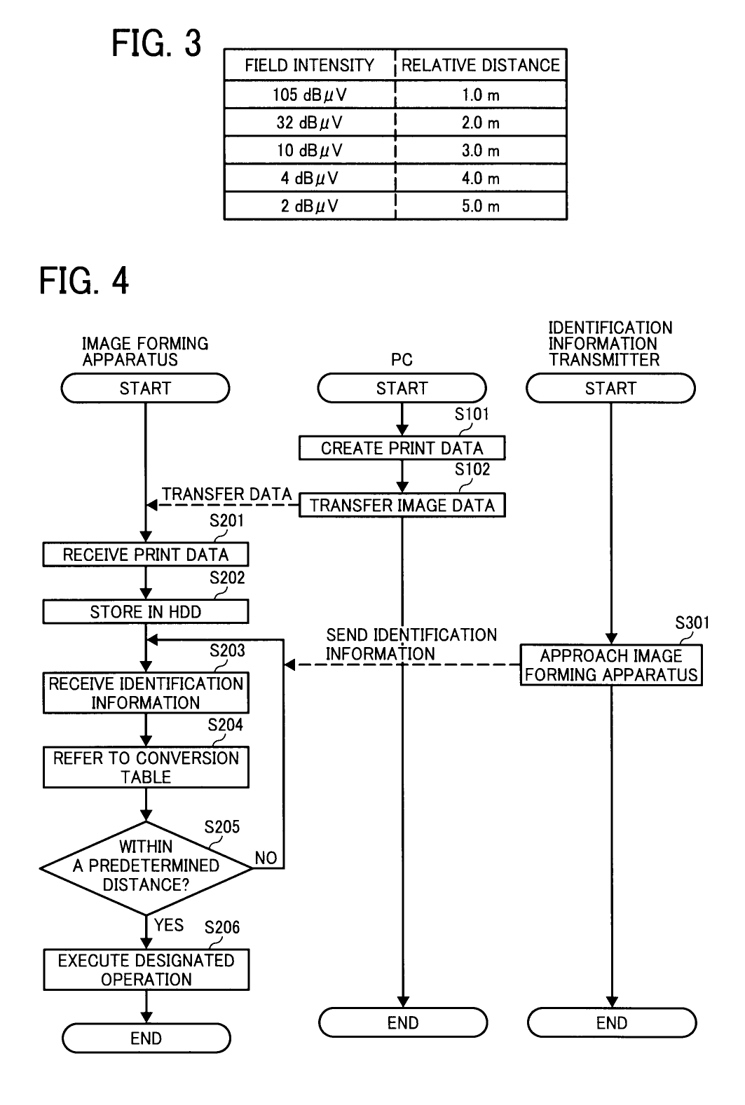

Referring now to FIG. 3, there is provided one example of the conversion table of the field intensity of the received signal and the relative distance.

As illustrated FIG. 3, in the conversion table 22D, different field intensities are listed in the left column, and corresponding relative distances are listed in the right column. A plurality of the field intensities and the corresponding relative distances are measured in advance and set in the conversion table 22D. For example, when the field intensity is 105 dBμV, the relative distance is approximately 1.0 m. When the field intensity is 2 dBμV, the relative distance is approximately 5.0 m.

Based on the correlation data stored in the conversion table 22D, the CPU 10 of the image forming apparatus 2 executes calculation processing in which, based on the calculated field intensity of the received signal, the relative distance between the identification information transmitter 4 that is the source of transmission of the identification information and the image forming apparatus 2 is calculated.

Furthermore, the image forming apparatus 2 compares the calculated relative distance with the preset distance and determines whether or not the identification information transmitter 4 is closer than a specified distance, or whether or not the identification information transmitter 4 is situated within a predetermined range, for example, within 1 m or 3 m.

Accordingly, based on the calculated relative distance, the image forming apparatus 2 verifies the distance to and relative position of the identification information transmitter 4, or closeness of the identification information transmitter 4 relative to the image forming apparatus 2. In accordance with the result or preset conditions, the CPU 10 regulates certain operations and carries out a specific operation.

The correlation between the field intensity to be measured and the relative distance depends on such conditions as the signal and the power source of each component, and also how the identification information transmitter 4 is carried by the user Y. For example, the user Y carries the identification information transmitter 4 with him or her in the same manner as when carrying a company employee ID card, or the identification information transmitter 4 may be embedded in a mobile phone. Also, there is unit-to-unit variation in the identification information transmitter 4 that also causes the correlation to vary. Thus, the correlation is not constant.

In order to accurately calculate the relative distance and employ the result in operation control, it is necessary to correct the correlation data (the conversion table 22D) for each identification information transmitter 4. Accordingly, the image forming apparatus 2 includes a correction mode in which data necessary for correction of the correlation data in the conversion table 22D is obtained. By operating the control panel 13, the image forming apparatus 2 can shift to the correction mode.

In particular, in the correction mode, the field intensity of the received signal from the identification information transmitter 4 is measured when the distance between the image forming apparatus 2 and the identification information transmitter 4 is at a constant distance. For example, the image forming apparatus 2 shifts to the correction mode, and the image forming apparatus 2 and the identification information transmitter 4 communicate with each other when the distance therebetween is a predetermined range, such as 1 m, 3 m, 5 m, and so forth.

With this configuration, the signal is received from the identification information transmitter 4 at a predetermined range or at a plurality of predetermined ranges corresponding to the data in the conversion table 22D. Subsequently, the field intensity is obtained at each distance. The CPU 10 calculates the field intensity of the received signal based on conditions including the predetermined range, thereby obtaining an amount of correction and then correcting the correlation data stored in the conversion table 22D using the correction amount thus obtained.

In other words, in a case in which the user Y sets the distance to be 3 m, for example, in the correction mode, the identification information transmitter 4 is disposed approximately 3 m away from the image forming apparatus 2, and the image forming apparatus 2 receives the identification information sent from the identification information transmitter 4 and measures the field intensity of the received signal.

The amount of correction is obtained by calculating the difference between the measured field intensity of the received signal and the field intensity at the corresponding distance in the conversion table 22D stored in the HDD 22. Based on this correction value, the field intensity is corrected, and the corrected field intensity is stored in the conversion table 22D as new correlation data.

According to the illustrative embodiment, the image forming apparatus 2 is equipped with a correction mechanism that corrects the correlation data based on the field intensity of the received signal received from the identification information receiver 4 situated at the predetermined range. The image forming apparatus 2 also includes an administration mechanism that administers the correlation data (conversion table 22D) stored in the HDD 22 to modify the data after correction.

With this configuration, the image forming apparatus 2 can obtain a relative distance to the identification information transmitter 4 with precision. The operation thereof is controlled based on the result, and appropriate operation is carried out in accordance with the preset conditions.

When the user Y moves with the identification information transmitter 4, the image forming apparatus 2 can identify based on the result of the calculation of the relative distance whether or not the user Y approaches the image forming apparatus 2 on the basis of the predetermined ranges, for example, 1 m, 3 m, 5 m, and so forth, or one of a plurality of distances.

Furthermore, based on changes in the calculation results of the relative distance, a moving speed of the user Y can be calculated. As a result, it is possible to identify whether or not the user Y approaches the image forming apparatus 2 because he or she wishes to use the image forming apparatus 2 or simply, the user Y is passing by.

Accordingly, the CPU 10 of the image forming apparatus 2 can identify the state of the user Y by comparing with the predetermined conditions, for example, and validates or cancels specific functions depending on the distance between the user Y and the image forming apparatus 2. For example, when the user Y does not move away or the user Y simply passes by the image forming apparatus 2, the image forming apparatus 2 is configured not to respond. In other words, the image forming apparatus 2 performs specific operations based on the calculation result of the relative distance.

Furthermore, according to the illustrative embodiment, the image forming apparatus 2 includes a plurality of power modes with different levels of power consumption. The apparatus can be switched between the different power modes. These modes include, for example, a normal power mode and one or more power-saving modes. In one or the plurality of the power-saving modes, power is not supplied to certain component so as to reduce consumption of power, thereby partially limiting operation of the image forming apparatus 2 as compared to the normal operating mode.

The image forming apparatus 2 further includes a switch mechanism that switches the power modes between the plurality of the power-saving modes based on the result of calculation of the relative distance described above, thereby enabling the image forming apparatus 2 to shift to and return from the power-saving mode consuming less power to resume normal operation.

For example, when the image forming apparatus 2 receives the identification information, the image forming apparatus 2 identifies the received identification information with the registered identification information transmitter 4 (the user Y). Accordingly, the user Y is specified. Subsequently, the print data transmitted from the user Y is stored in the HDD 22 and so forth, or when the print data is being received, the power mode changes to a printing stand-by state. At this time, if the apparatus is in the power-saving mode, an instruction signal to restart supply of power to a fixing unit, not illustrated, is sent to the power controller 21 via the engine control circuit 19, while the CPU 10 initiates a print processing program so as to enable the printing stand-by state.

By contrast, in the printing stand-by state, when the identification information transmitter 4 moves away from the image forming apparatus 2 so that the receive level of the signal of the identification information (field intensity) decreases and the calculated relative distance reaches or exceeds the predetermined range, the CPU 10 halts initialization of the print processing program and instructs the power controller 21 to stop supplying power to the fixing unit and shifts the apparatus into the power-saving mode.

As described above, the image forming apparatus 2 controls the apparatus and switches the power modes based on the result of calculation of the relative distance. When the image forming apparatus 2 detects the identification information transmitter 4 approaching to or coming into the predetermined range, the apparatus returns from the power-saving mode to the stand-by mode, or automatically shifts to the printable state.

By contrast, when the image forming apparatus 2 detects the identification information transmitter 4 moving away from the image forming apparatus 2 or moving outside the predetermined range, the apparatus is shifted into the power-saving mode so that printing can be performed only as needed.

Furthermore, in the image forming apparatus 2, items to be shown on the control screen of the control panel 13 can be set and changed for each user Y. In accordance with the results of calculation of the relative distance and the identification of the user Y based on the identification information, the items or the image shown on the control screen of the control panel 13 change for each user. In other words, in the image forming apparatus 2, the items to be shown on the control panel 13 or a user-specific screen including control contents can be set in advance and changed depending on the user Y.

When the identification information is received, the user Y is specified based on the user authentication and user-specific screen setting information is read out if the information is stored in the HDD 22.

Furthermore, when the image forming apparatus 2 detects the user Y approaching or coming into the predetermined range based on the result of calculation of the relative distance, the screen of the control panel 13 is automatically switched to the user-specific screen for the specified user. In the image forming apparatus 2, the control panel 13 shows the user-specific screen (image) in accordance with the user Y identified with the identification information transmitter 4.

Referring now to FIG. 4, there is provided a flowchart showing a print procedure performed by the image forming apparatus 2 in the information processing system 1, according to the illustrative embodiment. In FIG. 4, flows of processing for each of the image forming apparatus 2, the PC 3, and the identification information transmitter 4 of the user Y are shown.

At S101, the user Y operates the PC 3 to edit data so that print data, including image data, print instructions, and so forth, is created, and the print operation is initialized. Subsequently, at S102, the PC 3 connects to and communicates with the image forming apparatus 2 via the network, and adds the user information including the identification information of the user Y to the print data. The print data is then transferred to the network I/F 24 of the image forming apparatus 2 through the network I/F 37 of the PC 3.

Subsequently, at S201, when the image forming apparatus 2 receives the print data, the print data is temporarily stored in the RAM 12 via the ASIC 23. The print data is then subjected to compression and so forth so that the print data is stored in the HDD 22 as the print data (file) 22A. In the meantime, the CPU 10 controls the image forming apparatus 2 to search for a communicable identification information transmitter 4 (the wireless communication module 40) via the wireless communication module 29.

The identification information transmitter 4 wirelessly sends the identification information at predetermined intervals using the signal. When the user Y who has operated the PC 3 approaches the image forming apparatus 2 carrying the identification information transmitter 4 at S301, the image forming apparatus 2 receives the signal including the identification information from the identification information transmitter 4 at S203.

Upon reception of the signal, based on the received identification information of the user Y, the image forming apparatus 2 identifies the identification information transmitter 4 and the user, and measures the field intensity of the received signal.

At S204, the conversion table 22D (FIG. 3) is read out from the HDD 22 and referred. Based on the correlation data between the relative distance between the identification information transmitter 4 and the image forming apparatus 2, and the field intensity of the received signal, the relative distance between the image forming apparatus 2 and the identification information transmitter 4 is calculated.

In accordance with the calculation result of the relative distance, the image forming apparatus 2 is controlled to execute the predetermined operation in accordance with the preset conditions. According to the illustrative embodiment, at S205, the image forming apparatus 2 determines whether or not the identification information transmitter 4 is within the predetermined range. If, at S205, it is determined that the identification information transmitter 4 is outside the predetermined range (NO in S205), the image forming apparatus 2 repeats its search to receive the identification information and calculate the relative distance (S203 and S204).

By contrast, if, at S205, it is determined that the identification information transmitter 4 approaches the predetermined range (YES in S205), the image forming apparatus 2 executes the specific operation in which, for example, the power mode is switched between the plurality of power modes with different power consumptions at S206.

When the screen of the control panel 13 of the image forming apparatus 2 is set to the user-specific screen in advance, the screen of the control panel 13 is changed to an appropriate screen for the user Y based on the calculation result of the relative distance between the image forming apparatus 2 and the user and the identification of the user Y.

In addition, in the information processing system 1 according to the illustrative embodiment described above, with a predetermined or arbitrary operation interval the user Y can activate the correction mode in the image forming apparatus 2 in which the correlation data between the field intensity of the received signal and the relative distance is corrected. Upon correction, the image forming apparatus 2 receives the signal from the identification information transmitter 4 situated at the predetermined range. Based on the measured field intensity of the received signal, the correlation data (the conversion table 22D) is corrected. The corrected correlation data is newly stored in the HDD 22 and used to calculate the relative distance from the field intensity.

According to the illustrative embodiment, in order to correct the correlation data between the relative distance and the field intensity, the information processing system 1 can obtain the relative distance with precision while accommodating different conditions and fluctuation of the field intensity.

The field intensity of the received signal, in particular, changes due to the state of the power source and with time. However, when this correction is performed, the accuracy of the correlation data between the field intensity and the relative distance can be maintained. The relative position can be calculated with precision for an extended period of time.

Furthermore, the image forming apparatus 2 is controlled based on the calculated relative distance and the like, so that a certain function(s) is enabled or disabled under an intended condition, or a predetermined operation is performed, thus enhancing usability by the user Y and accuracy of control.

Still further, according to the illustrative embodiment described above, since the power mode of the image forming apparatus 2 is changed based on the relative distance from the image forming apparatus 2 to the identification information transmitter 4, the apparatus can automatically be shifted to the power-saving mode depending on the closeness of the user Y. For example, power can be reduced during the stand-by mode, thereby reducing power consumption as a whole.

Moreover, before the user Y moves to in front of the image forming apparatus 2 to operate the image forming apparatus 2, power to the image forming apparatus can be returned to the normal mode from the power-saving mode, thereby shortening the waiting period. With this configuration, reduction in the waiting period as well as the power consumption can be achieved.

When the specific identification information transmitter 4 approaches the image forming apparatus 2, the screen of the control panel 13 of the image forming apparatus 2 changes without physically operating the screen to show the user-specific screen. This enhances usability and convenience for the user Y. For this reason, if a blind person, for example, approaches the image forming apparatus 2, the user-specific screen with which he or she is familiar is shown, thereby preventing an operation error or the like.

As a customization service of a screen for image forming apparatuses is widely practiced in recent years, the illustrative embodiment can be applied to such a service.

The screen can be changed based on a plurality of information in addition to the identification information of the identification information transmitter 4 of the user Y, so as to increase security and avoid complication upon switching the screen to a higher security level screen that is limited to a particular user. In this case, the user Y is identified based on the identification information transmitter 4 as well as another identification information transmitter 4′ to change the screen.

For example, in addition to the identification information transmitter 4 that specifies the user Y, the user Y, who is authorized to perform maintenance and system administration, carries another identification information transmitter 4′ in which the identification information specific to a key to administration of the system is set. When the user Y with both the identification information transmitters 4 and 4′ approaches the image forming apparatus 2, the image forming apparatus 2 receives both information.

Only when both the identification information transmitters 4 and 4′ come within the predetermined range does the control panel 13 automatically show the screen for the administrator, or the screen that is normally not accessible. Accordingly, security can be increased and complication in changing the screen of the control panel 13 can be avoided.

According to the illustrative embodiment described above, the identification information of the user Y is wirelessly sent from the identification information transmitter 4. Alternatively, the identification information that identifies an external device, for example, the PC 3, or any other identification information of the external device may be wirelessly sent. In this case, the result of identification and the result of calculation of the relative distance are associated with data from the PC 3.

With this configuration, the identification information transmitter 4 wirelessly sends the identification information of the user Y of the external device or the external device itself.

According to the illustrative embodiment described above, the power mode and the screen of the control panel 13 can be changed based on the result of calculation of the relative distance. Alternatively, depending on the functions of the image forming apparatus 2, not only the power mode and the screen but also other operations and processes can be carried out based on the result of calculation of the relative distance.

Next, a description is provided of a variation of the foregoing embodiment. The configuration of the information system 1 according to the variation of the foregoing embodiment is similar to, or if not the same as that of the embodiment 1. Thus, the description is provided only of the difference in the image forming apparatus 2.

### Embodiment 2

According to the present embodiment, in the information processing system 1, the image forming apparatus 2 processes the received data from the PC 3 of the user Y or stops processing based on the calculation result of the relative distance to the identification information transmitter 4 as well as the identification result of the user Y of the identification information transmitter 4 which is the source of transmission.

When the image forming apparatus 2 detects the identification information transmitter 4 approaching based on the calculated relative distance therebetween obtained from the field intensity, similar to the foregoing embodiment, the identification information transmitter 4 (the user Y) is identified and specified based on the received identification information.

In addition, the image forming apparatus 2 searches the user information attached to the print data received from the PC 3. If the received print data is from the specified user Y, after detecting that the identification information transmitter 4 is in the vicinity of the predetermined range, the image forming apparatus 2 initiates printing of the data and prints out the document.

By contrast, when the image forming apparatus 2 detects that the identification information transmitter 4 moved away to a predetermined range or even further while the image forming apparatus 2 prints out the print data of the user Y, the image forming apparatus 2 specifies the identification information transmitter 4 (the user Y) based on the identification information, and halts printing and operation.

While the image forming apparatus 2 receives print data of a plurality of users Y1 through Y4 and stores the data in the HDD 22, and the user Y2 approaches a certain distance, for example, 1 m or closer with the identification information transmitter 4, the image forming apparatus 2 recognizes the user Y2 based on the identification information and starts printing the print data of the user 2Y.

When the identification information transmitters 4 for the users Y1 through Y4 are in a communicable state, the print data of the user Y among the users Y1 through Y4 who is identified to be at the closest position to the image forming apparatus 2 is processed.

Alternatively, when the identification information transmitter 4 of the user Y among the users Y1 through Y4 whose relative distance to the image forming apparatus 2 becomes shorter and shorter, that is, the identification information transmitter 4 approaches and the distance therebetween is equal to or less than a predetermined range, for example, 3 m, the image forming apparatus 2 processes the print data of the user Y.

By contrast, in a case in which the user Y2 is in the vicinity of the image forming apparatus 2 and thus printing is being carried out, when the identification information transmitter 4 of the user Y2 moves away and the image forming apparatus 2 determines that the relative distance became equal to or greater than the specific distance, for example, 2 m, based on the calculation result, printing and/or the present operation is halted. In the meantime, the user-specific screen for the user Y2 on the control panel 13 is switched to a different screen or hidden so as to prevent the information of the user Y2 from leaking. When the user Y2 approaches the image forming apparatus 2 again, printing is resumed. In a case in which the user Y2 approaches the image forming apparatus 2 before printing is completely stopped, printing is continued.

According to the present embodiment, the image forming apparatus 2 includes an execution mechanism that executes image forming processing on the print data (image data) received from the PC 3 of the user Y based on the calculation result of the relative distance and the identification of the user Y. Accordingly, when the image forming apparatus 2 receives the print data of the user Y, the image forming apparatus 2 performs print processing on the print data and outputs.

Furthermore, the image forming apparatus 2 includes a stop mechanism that halts the image forming processing on the image data received from the PC 3 of the user Y based on the calculation result of the relative distance and the identification of the user Y.

With this configuration, in the information processing system 1, in accordance with physical closeness of the user Y who instructs printing, the image forming apparatus 2 can start printing. If printing is instructed in advance, the PC 3 can execute other processing, or the PC 3 can be turned off.

In addition, when the user Y approaches the image forming apparatus 2 to retrieve the printed document, printing can be started and the printed document can be obtained, thereby enhancing convenience and reducing waiting time for printing and so forth. Until the user Y approaches the image forming apparatus 2, the image forming apparatus 2 does not start printing, preventing illegal access to the printed document by other people or from getting stolen, and thus maintaining security for the document.

Still further, when the user Y moves away from the image forming apparatus 2 while printing, printing is temporarily halted, thus also preventing illegal access to the document by other people. As the user Y approaches the image forming apparatus 2 again, printing is resumed, thereby enhancing convenience.

### Embodiment 3

Next, a description is provided of another variation of the foregoing embodiments. When compared with the first illustrative embodiment, the image forming apparatus 2 of the information processing system 1 includes an access right setting mechanism that sets an access authorization or control level (accessible area) relative to operation of the control screen of the control panel 13, data, and so forth, or sets permission and prohibition of access for each user Y of the identification information transmitter 4.

With this configuration, the access authorization level or permission and prohibition of access can be set for each user Y (the identification information transmitter 4) in advance in the image forming apparatus 2. Based on this setting, the control screen or the image on the control panel 13 is changed to an appropriate screen or the image that is unique to the user Y.

Alternatively, the image forming apparatus 2 is equipped with an alert system including an audio alarm and/or a visual alarm provided at a predetermined position that generates sound or flashes light to alert the user.

The image forming apparatus 2 includes an administration mechanism that administers an access right of the user Y. Based on the identification information of the user, when the image forming apparatus 2 detects the user Y′ who does not possess the access right or is prohibited to a certain access, the control screen is changed to an appropriate screen or an appropriate image in accordance with a preset condition.

With this configuration, while the present user Y operates the control screen, when the image forming apparatus 2 detects another user Y′ who is not authorized to operate or access data, the image forming apparatus 2 shows the alert screen on the control panel 13 or scrambles the control screen, thereby alerting the user Y of the presence of another user Y′. In the meantime, a password or a setting value displayed on the control screen, or an image thumbnail constituting the screen display is prevented from being illegally read.

By contrast, when the image forming apparatus 2 detects the user Y who possesses the predetermined access right approaching, the control screen is changed to the screen appropriate for the access right from the restricted screen on which the controllable items are limited.

When the image forming apparatus 2 includes the alert system, upon detection of the illegal user Y′ whose access is prohibited, the image forming apparatus 2 alerts the user by switching the screen and/or by activating the alert system. When the alert system is activated, the audio alarm including a buzzer and/or a speaker and so forth generates alert sound, or the visual alarm such as a Light Emitting Diode (LED) flashes light, thereby making the user aware of the user Y′. The alert system includes, but is not limited to the audio alarm and the visual alarm. Any other methods that can alert the user Y can be implemented.

According to the present embodiment, the image forming apparatus 2 receives the access authorization level information attached to the user information sent with the print data from the PC 3 and the identification information of the user from the identification information transmitter 4. Based on the identification information sent from the identification information transmitter 4, identification and authentication of the user as well as the access authorization level information are verified.

The access authorization level can be configured such that, for example, when the access authorization level of the user is Level 1, the user has access to all data. When the access authorization level is Level 2, the user has access to only a part of data. Accordingly, when the image forming apparatus 2 detects the user Y′ (the identification information transmitter 4) of the access authorization level of Level 2 approaching while the user Y of Level 1 carries out printing in front of the image forming apparatus 2, the present control screen of the control panel 13 being shown is changed to alert the user Y.

Alternatively, the alert system such as the audio alarm and the visual alarm is activated to alert the user Y of another user, the user Y′, whose access authorization level is lower than the user Y, approaching the image forming apparatus 2.

Furthermore, when the user Y′ moves away, the image forming apparatus 2 halts the alert system and switches the screen to the appropriate control screen for the present user Y.

With this configuration, the information processing system 1 prevents the user Y′ from furtively glancing at the control screen or the data. Furthermore, the information processing system 1 alerts the user Y of the user Y′ approaching the image forming apparatus 2, thereby notifying the user Y of the surrounding environment and thus increasing security. In a case in which the user Y does not possess the identification information transmitter 4, the user Y is not allowed to access the print data so as to prohibit printing, thereby also increasing security for data access.

It will be appreciated that all or part of the devices and functions including the correction mechanism of the image forming apparatus 2 are realized in the information processing apparatus.

Furthermore, the information processing apparatus is configured to execute the same steps as executed in the information processing system 1 (the image forming apparatus 2). Therefore, the present invention can be realized as a control method of the information processing apparatus.

The present invention can be also realized by providing a computer program that directs the computer to execute each step of the control method of the information processing apparatus. The computer program can be written in a known program language. Storage media used to deliver the computer program may include flexible disks, CD-ROMs, DVD-ROMs, MOs, and so forth that can be read by the computer.

The operation control mechanism of the image forming apparatus includes an execution mechanism that processes the received data and a stop mechanism to stop processing the received data. The execution mechanism of the operation control mechanism also executes image forming processing on the received image data by the image forming apparatus. The stop mechanism of the operation control mechanism also stops image forming processing relative to the received image data by the image forming apparatus.

Furthermore, it is to be understood that elements and/or features of different illustrative embodiments may be combined with each other and/or substituted for each other within the scope of this disclosure and appended claims. In addition, the number of constituent elements, locations, shapes and so forth of the constituent elements are not limited to any of the structure for performing the methodology illustrated in the drawings.

Still further, any one of the above-described and other exemplary features of the present invention may be embodied in the form of an apparatus, method, or system.

For example, any of the aforementioned methods may be embodied in the form of a system or device, including, but not limited to, any of the structure for performing the methodology illustrated in the drawings.

Example embodiments being thus described, it will be obvious that the same may be varied in many ways. Such exemplary variations are not to be regarded as a departure from the scope of the present invention, and all such modifications as would be obvious to one skilled in the art are intended to be included within the scope of the following claims.

What is claimed is:

1. An information processing apparatus, comprising:
a communication unit to communicate with an external device;
a receiver to receive a signal from an identification information transmitter that transmits at least one of identification information of a user of the external device and identification information of the external device;
a measurement circuit to measure a field intensity of a received signal;
a storage unit to store correlation data between a relative distance from the information processing apparatus to the identification information transmitter and the field intensity of the received signal;
a calculation circuit to calculate, from the field intensity of the received signal, the relative distance based on the correlation data;
an operation controller to control operation of the information processing apparatus based on a result of calculation of the relative distance by the calculation circuit; and
a correction unit to correct the correlation data based on the field intensity of the received signal from the identification information transmitter disposed at a predetermined range.

2. The information processing apparatus according to claim 1, wherein the operation controller switches the information processing apparatus between a plurality of power modes with different levels of power consumption based on the calculated relative distance.

3. The information processing apparatus according to claim 1, further comprising a display device to show a screen that is unique to and set for each user,
wherein the operation controller identifies the user based on the received identification information of the user, and changes the screen based on the calculated relative distance and the result of identification of the user.

4. The information processing apparatus according to claim 1, wherein the operation controller identifies the user based on the received identification information of the user, and executes or stops processing relative to the received data from the external device of the identified user based on the calculated relative distance and the result of identification of the user.

5. The information processing apparatus according to claim 1, wherein the operation controller identifies the user based on the received identification information of the user and sets an access authorization level or permission and prohibition of access for each user, and
wherein the operation controller changes the screen based on the calculated relative distance, the result of identification of the user, and the access authorization level or permission and prohibition of access of the user.

6. The information processing apparatus according to claim 1, wherein the operation controller identifies the user based on the received identification information of the user and sets an access authorization level or permission and prohibition of access for each user, and
wherein the operation controller alerts the user based on the calculated relative distance, the result of identification of the user, and the access authorization level or permission and prohibition of access of the user.

7. An image forming apparatus for forming an image, comprising:
an image bearing member to bear an electrostatic latent image on a surface thereof;
a developing device to develop the electrostatic latent image formed on the image bearing member using toner to form a toner image;
a transfer device to transfer the toner image onto the recording medium;
a fixing device to fix the toner image; and
the information processing apparatus of claim 1.

8. A control method used in an information processing apparatus,
the information processing apparatus comprising:
a communication unit to communicate with an external device;
a receiver to receive a signal from an identification information transmitter that transmits at least one of identification information of a user of the external device and identification information of the external device;
a measurement circuit to measure a field intensity of a received signal;
a storage unit to store correlation data between a relative distance from the information processing apparatus to the identification information transmitter and the field intensity of the received signal;
a calculation circuit to calculate from the field intensity of the received signal the relative distance based on the correlation data;
an operation controller to control operation of the information processing apparatus based on a result of calculation of the relative distance by the calculation circuit; and
a correction unit to correct the correlation data based on the field intensity of the received signal from the identification information transmitter disposed at a predetermined range,
the method comprising:
communicating with an external device;
receiving a signal from an identification information transmitter that transmits at least one of identification information of a user of the external device and identification information of the external device;
measuring a field intensity of a received signal;
calculating, from the field intensity of the received signal, a relative distance from the information processing apparatus to the identification information transmitter based on correlation data between the relative distance and the field intensity of the received signal;
controlling operation of the information processing apparatus based on a result of calculation of the relative distance;
correcting the correlation data based on the field intensity of the received signal from the identification information transmitter disposed at a predetermined range; and
storing the corrected correlation data.

9. The method according to claim 8, wherein the controlling comprises switching between a plurality of power modes with different levels of power consumption based on the calculated relative distance.

10. The method according to claim 8, further comprising:
identifying the user based on the received identification information of the user; and
setting a screen of a display device unique for each user,
wherein the controlling further includes changing the screen based on the calculated relative distance and the result of identification of the user.

11. The method according to claim 8, further comprising:
identifying the user based on the received identification information of the user,
wherein the controlling further includes executing or stopping processing of the data received from the external device of the user based on the calculated relative distance and the result of identification of the user.

12. The method according to claim 8, further comprising:
identifying the user based on the received identification information of the user; and
setting an access authorization level for each user, or permission and prohibition of access for each user
wherein the controlling further includes changing a control screen used for control by the user or alarming the user in accordance with the access authorization level of the user or the permission and prohibition of access of the user based on the calculated relative distance and the result of identification of the user.

13. A computer program product comprising a computer-usable medium having computer-readable program codes embodied in the medium that, when executed, causes a computer to execute a control method, the method comprising:
communicating with an external device;
receiving a signal from an identification information transmitter that transmits at least one of identification information of a user of the external device and identification information of the external device;
measuring a field intensity of a received signal;
calculating, from the field intensity of the received signal, a relative distance from an information processing apparatus to the identification information transmitter based on correlation data between the relative distance and the field intensity of the received signal;
controlling operation of the information processing apparatus based on a result of calculation of the relative distance;
correcting the correlation data based on the field intensity of the received signal from the identification information transmitter disposed at a predetermined range; and
storing the corrected correlation data.
